(19) United States
(12) Patent Application Publication
(10) Pub. No.: US 2024/0239281 A1
(43) Pub. Date: Jul. 18, 2024

(54) VEHICLE POWER SUPPLY SYSTEM

(71) Applicant: TOYOTA JIDOSHA KABUSHIKI KAISHA, Toyota-shi (JP)

(72) Inventors: Toshiyuki MAEGAITO, Tayota-shi (JP); Shinichi Inoue, Okazaki-shi (JP)

(73) Assignee: TOYOTA JIDOSHA KABUSHIKI KAISHA, Toyota-shi (JP)

(21) Appl. No.: 18/483,834

(22) Filed: Oct. 10, 2023

(30) Foreign Application Priority Data
Jan. 12, 2023 (JP) 2023-003145

(51) Int. Cl. B60R 16/033; H02J 7/34

(52) U.S. Cl. CPC B60R 16/033; H02J 7/342

(57) ABSTRACT

A vehicle power supply system includes a direct current-direct current converter, an alternator, and a control unit. The direct current-direct current converter supplies battery power to the first device and the second device. The alternator is connected in parallel with the direct current-direct current converter and supplies generated power to the first device and the second device. The control unit detects a switch operation for starting and stopping the second device. The alternator supplies the generated power to the first device and the second device when the control unit detects a switch operation that activates the second device.

### CROSS-REFERENCE TO RELATED APPLICATION

This application claims priority to Japanese Patent Application No. 2023-003145 filed on Jan. 12, 2023 incorporated herein by reference in its entirety.

### BACKGROUND

### 1. Technical Field

The present disclosure relates to a power supply system mounted on a vehicle.

### 2. Description of Related Art

In Japanese Patent Application No. 2020-074737, a vehicle power supply system is disclosed that has a configuration in which an alternator is provided in parallel with a direct current-direct current converter to deal with electric power shortage in an auxiliary system that is associated with addition of a mounted device, in vehicles such as a hybrid electric vehicle (HEV) and a plug-in hybrid electric vehicle (PHEV).

The above-mentioned Japanese Patent Application No. 2020-074737 discloses a method of cooperatively controlling power generation of the alternator in accordance with the load state of the direct current-direct current converter, and there is a problem that the configuration of the power supply system is complicated and the cost is high.

### SUMMARY

The present disclosure has been made in view of the above issues, and an object of the present disclosure is to provide a vehicle power supply system capable of cooperatively controlling a direct current-direct current converter and an alternator with a simple configuration and at low cost.

In order to solve the above issues, an aspect of the technique of the present disclosure is a vehicle power supply system including: a direct current-direct current converter that supplies electric power of a battery to a first device and a second device; an alternator that is connected in parallel with the direct current-direct current converter and that is able to supply generated electric power to the first device and the second device; and a control unit that detects a switch operation to activate and stop the second device. The alternator supplies the generated electric power to the first device and the second device, when the switch operation to activate the second device is detected by the control unit.

With the vehicle power supply system of the present disclosure, the switch operation to activate the second device is used as a trigger to supply the generated electric power from the alternator to the first device and the second device. Thereby, the direct current-direct current converter and the alternator can be cooperatively controlled with a simple configuration and at low cost.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a vehicle power supply system and its peripherals according to an embodiment of the present disclosure;

FIG. 2A is a processing flowchart of power control executed by the vehicle power supply system; and

FIG. 2B is a processing flowchart of power control executed by the vehicle power supply system.

### DETAILED DESCRIPTION OF EMBODIMENTS

A vehicle power supply system of the present disclosure includes a direct current-direct current converter that supplies power from a battery to a load, and an alternator that is connected to the load in parallel with the direct current-direct current converter. When a power shortage occurs due to the operation of a specific load, the vehicle power supply system detects the operation of a switch that activates the specific load, and supplies the power generated by the alternator to the load in parallel with the power of the direct current-direct current converter. This enables coordinated control of the direct current-direct current converter and the alternator with a simple configuration and low cost.

Hereinafter, an embodiment of the present disclosure will be described in detail with reference to the drawings.

### EMBODIMENT

### Configuration

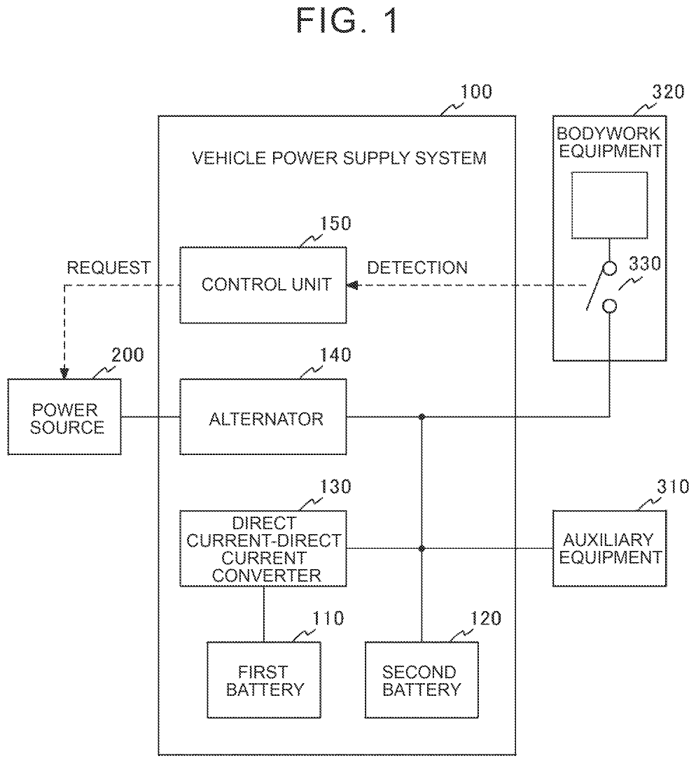

FIG. 1 is a functional block diagram showing a schematic configuration of a vehicle power supply system 100 and its peripheral parts according to an embodiment of the present disclosure. The functional block illustrated in FIG. 1 includes a vehicle power supply system 100, a power source 200, auxiliary device 310 and mounted device 320. This vehicle power supply system 100 is mounted in a vehicle such as a hybrid electric vehicle or a plug-in hybrid electric vehicle.

Vehicle power supply system 100 is configured to control power supply to auxiliary device 310 and mounted device 320. This vehicle power supply system 100 includes a first battery 110, a second battery 120, a direct current-direct current converter 130, an alternator 140 and a control unit 150.

The first battery 110 is a rechargeable secondary battery such as a lithium ion battery or a nickel metal hydride battery. The first battery 110 can output stored power to the direct current-direct current converter 130. An example of the first battery 110 is a high-voltage drive battery (high-voltage battery) that supplies electric power for the vehicle to run.

The second battery 120 is a rechargeable secondary battery such as a lead battery or a lithium ion battery. Second battery 120 can output stored electric power to auxiliary device 310 and mounted device 320. In addition, the second battery 120 can charge the power of the first battery 110 supplied through the direct current-direct current converter 130 or the power generated by the alternator 140. An example of the second battery 120 is an auxiliary battery that supplies power to loads such as the auxiliary device 310 and the mounted device 320.

The direct current-direct current converter 130 is a voltage converter that is provided between the first battery 110, and the auxiliary device 310 and the mounted device 320, and that converts the electric power of the first battery 110 into electric power with a voltage suitable for the auxiliary device 310 and the mounted device 320, and outputs the electric power to the auxiliary device 310 and the mounted device 320. The operation of direct current-direct current converter 130 is controlled by an instruction from control unit 150 in response to a request from auxiliary device 310 and/or mounted device 320. As the direct current-direct current converter 130, a step-down direct current-direct current converter that steps down the voltage of the first battery 110 and outputs it to the auxiliary device 310 and the mounted device 320 can be exemplified.

Alternator 140 is a generator that can generate power according to the operation (driving) of power source 200. The alternator 140 is connected in parallel with the direct current-direct current converter 130 so that the electric power generated by the alternator 140 and the electric power generated by the direct current-direct current converter 130 can be output to the auxiliary device 310 and the mounted device 320. Whether or not the alternator 140 outputs the power generated is controlled by the control unit 150.

Control unit 150 controls operations of direct current-direct current converter 130 and alternator 140. More specifically, the control unit 150 gives instructions to the direct current-direct current converter 130 to implement the power supply from the first battery 110 to the auxiliary device 310 and the mounted device 320 in response to power requirements of the auxiliary device 310 and/or the mounted device 320. Further, the control unit 150 controls the operation (power generation state) of the alternator 140 based on the operation status of the mounted device 320. During this control, the control unit 150 can acquire physical quantities (voltage, current, temperature, etc.) of the second battery 120 via a detection sensor (not shown) or the like, and can acquire the operation status of the mounted device 320 by sensing the on/off state of activation switch 330. The control of this control unit 150 will be described later.

The control unit 150 described above can typically be configured by an electronic control unit (ECU) including a processor such as a microcomputer, a memory, an input/output interface, and the like. The electronic control unit can implement some or all of the functions performed by the control unit 150 described above by the processor reading out and executing a program stored in the memory.

Power source 200 is an internal combustion engine such as an engine or an electric motor such as a motor. The power source 200 can operate/stop itself based on the operation request/stop request output from the control unit 150. This power source 200 can generate power for driving the vehicle, and is configured to be used for power supply to auxiliary device 310 and mounted device 320 and charging of second battery 120.

Auxiliary device 310 is a load (first device) such as an electronic device or equipment mounted on the vehicle that consumes electric power. This auxiliary device 310 is configured to operate with the power of the first battery 110 and the power of the second battery 120 supplied via the direct current-direct current converter 130. Auxiliary device 310 can be exemplified by electronic devices such as a headlamp, wiper, meter, and ECU that are mounted as standard equipment on the vehicle.

The mounted device 320 is a load (second equipment) such as electronic equipment and equipment mounted on the vehicle that consumes electric power. In principle, the mounted device 320 is configured to operate with the power of the first battery 110 and the power of the second battery 120 supplied via the direct current-direct current converter 130. The mounted device 320 is a load that may be insufficient in power with only the power of the first battery 110 and the second battery 120 depending on how it is used. As the mounted device 320, an electronic device such as an additional lamp mounted as optional equipment on the vehicle can be exemplified. In addition, the mounted device 320 includes an activation switch 330 that controls conduction/non-conduction of electric power for driving itself. The mounted device 320 is configured to notify the control unit 150 of the vehicle power supply system 100 of the on/off state of the activation switch 330 when mounted on the vehicle. Note that the activation switch 330 may be provided on the vehicle side instead of the mounted device 320, and in this case, the connection destination (connector or the like) of the mounted device 320 is determined in advance.

### Control

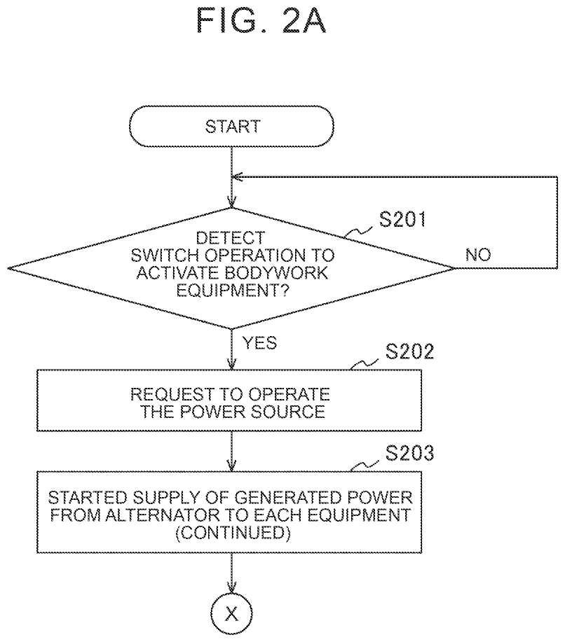

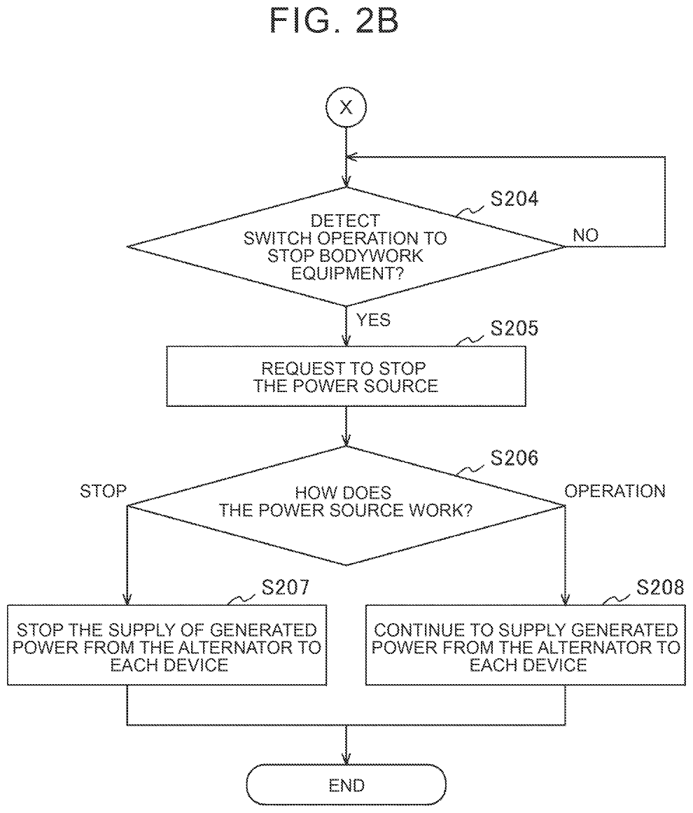

Next, control performed by the vehicle power supply system 100 according to the present embodiment will be described with further reference to FIGS. 2A and 2B. FIGS. 2A and 2B are flowchart illustrating power control processing procedures executed by vehicle power supply system 100. The processing in FIG. 2A and the processing in FIG. 2B are connected by a connector X.

### S201

The control unit 150 determines whether an operation (ON operation) of the activation switch 330 for starting the mounted device 320 has been detected. The control unit 150 can determine the ON operation by, for example, detecting an ON signal flowing through a direct line connected to the mounted device 320 in response to the ON operation of the activation switch 330. When the control unit 150 detects the operation of the activation switch 330 that activates the mounted device 320 (S201, Yes), the process proceeds to S202. Otherwise (S201, No), the control unit 150 waits until the activation switch 330 is turned on.

### S202

Control unit 150 issues an operation request to power source 200. The power source 200 that has received this operation request continues to operate if it has already operated, or starts operating if it has not yet operated. Alternator 140 operates according to the operation of power source 200. Alternator 140 generates electric power according to the operation of power source 200. When the control unit 150 requests the power source 200 to operate, the process proceeds to S203.

### S203

The control unit 150 supplies (outputs) power generated by the alternator 140 to the auxiliary device 310 and the mounted device 320. This allows direct current-direct current converter 130 and alternator 140 to supply power to auxiliary device 310 and mounted device 320 in parallel. When the control unit 150 supplies the electric power generated by the alternator 140 to the auxiliary device 310 and the mounted device 320, the process proceeds to S204.

### S204

The control unit 150 determines whether an operation (OFF operation) of the activation switch 330 for stopping the mounted device 320 has been detected. The control unit 150 can determine the OFF operation by, for example, detecting an OFF signal flowing through the direct line connected to the mounted device 320 in response to the OFF operation of the activation switch 330. When the control unit 150 detects the operation of the activation switch 330 to stop the mounted device 320 (S204, Yes), the process proceeds to S205. Otherwise (S204, No), the control unit 150 continues the operation of the power source 200 until activation switch 330 is turned on (continues the power supply from the alternator 140 to the auxiliary device 310 and the mounted device 320).

### S205

Control unit 150 requests power source 200 to stop. Upon receiving this stop request, power source 200 determines whether it is possible to stop its operation in response to the stop request. Specifically, power source 200 determines whether it is possible to stop its own operation based on whether or not it receives an operation request from a device or system other than vehicle power supply system 100. An example of a state in which the power source 200 cannot be stopped and requires an operation request is a case where the first battery 110 is low in charge and may run out of power unless it is charged. When control unit 150 issues a request to stop power source 200, the process proceeds to S206.

### S206

Power source 200 determines whether to stop or continue operation. This determination is made based on the presence or absence of an operation request for power source 200 as described above. If it is determined that the power source 200 should stop operating (S206, stop), the process proceeds to S207. On the other hand, if the power source 200 determines to continue the operation (S206, operation), the process proceeds to S208.

### S207

Control unit 150 stops supplying (outputting) electric power generated by alternator 140 to auxiliary device 310 and mounted device 320 in response to the stoppage of operation of power source 200. As a result, power from only direct current-direct current converter 130 can be supplied to auxiliary device 310. When the supply of power generated by alternator 140 is stopped by control unit 150, this power control ends.

### S208

Control unit 150 continues to supply (output) power generated by alternator 140 to auxiliary device 310 and vehicle body device 320 in response to continued operation of power source 200. As a result, direct current-direct current converter 130 and alternator 140 supply power to auxiliary device 310 in parallel. When the control unit 150 maintains the supply of the power generated by the alternator 140, this power control ends.

### Operations and Effects

As described above, the vehicle power supply system 100 according to an embodiment of the present disclosure includes the direct current-direct current converter 130 that supplies the electric power of the first battery 110 to the auxiliary device 310 and the mounted device 320, and the generated electric power to the auxiliary device. 310 and an alternator 140 capable of supplying the mounted device 320 are connected in parallel. The vehicle power supply system 100 detects the operating state of the mounted device 320 by operating the activation switch 330. Then, vehicle power supply system 100 detects an ON operation of activation switch 330 that starts mounted device 320 to start power source 200 and control alternator 140 to generate power.

In this way, the vehicle power supply system 100 detects the on/off operation of the physical activation switch 330 (abolition of the excitation current limiting function and drooping state monitoring function in the above-mentioned Japanese Patent Application No. 2020-074737), and the direct current-direct current converter 130 determine the conditions under which the power may become insufficient. The direct current-direct current converter 130 and alternator 140 can output electric power to auxiliary device 310 and mounted device 320 in parallel. Therefore, direct current-direct current converter 130 and alternator 140 can be cooperatively controlled with a simple configuration and at low cost.

An embodiment of the present disclosure has been described above, but the present disclosure includes not only a vehicle power system, but also a method executed by a vehicle power system including a processor, a memory, etc., a program for executing this method, and a program. It can be regarded as a computer-readable non-temporary storage medium in which data is stored, a vehicle equipped with a vehicle power supply system, and the like.

A vehicle power supply system according to the present disclosure can be used in a vehicle equipped with a power supply system including a direct current-direct current converter and an alternator.

What is claimed is:

1. A vehicle power supply system comprising:
a direct current-direct current converter that supplies electric power of a battery to a first device and a second device;
an alternator that is connected in parallel with the direct current-direct current converter and that is able to supply generated electric power to the first device and the second device; and
a control unit that detects a switch operation to activate and stop the second device, wherein the alternator supplies the generated electric power to the first device and the second device, when the switch operation to activate the second device is detected by the control unit.

2. The vehicle power supply system according to claim 1, wherein when the switch operation to stop the second device is detected by the control unit, the alternator stops or continues supplying the generated electric power to the first device and the second device, based on a state of a power source that drives the alternator.

3. The vehicle power supply system according to claim 2, wherein when the switch operation to stop the second device is detected by the control unit, the alternator stops supplying the generated electric power to the first device and the second device in a case where the power source is in a state in which the power source does not need to operate.
